(19) United States
(12) Patent Application Publication
(10) Pub. No.: US 2024/0367270 A1
(43) Pub. Date: Nov. 7, 2024

(54) SOLDER PARTICLES, METHOD FOR PRODUCING SOLDER PARTICLES, AND CONDUCTIVE COMPOSITION

(71) Applicant: DEXERIALS CORPORATION, Tochigi (JP)

(72) Inventors: Hidetsugu NAMIKI, Tochigi (JP); Sarii YAMAGUCHI, Tochigi (JP); Takeshi NISHIO, Tochigi (JP)

(21) Appl. No.: 18/682,007

(22) PCT Filed: Jul. 27, 2022
(86) PCT No.: PCT/JP2022/028929

§ 371 Date: Feb. 7, 2024

(30) Foreign Application Priority Data
Aug. 27, 2021 (JP) 2021-138864

(51) Int. Cl. B23K 35/02; B22F 1/05; B22F 1/145; B23K 35/26; B23K 35/365

(52) U.S. Cl. CPC B23K 35/0244; B22F 1/05; B22F 1/145; B23K 35/264; B23K 35/365; B22F 2301/30; B22F 2304/10; B22F 2998/10

(57) ABSTRACT

Solder particles containing an oxidized film on the surface thereof, wherein the average film thickness of the oxidized film is 3 nm or greater, and the average surface roughness Ra of the solder particles is 10 nm or greater are provided.

### TECHNICAL FIELD

The present invention relates to solder particles, a method for producing solder particles, and a conductive composition.

### BACKGROUND ART

Currently commercially-available solder particles are less uniform in particle diameter than (i.e., have a wider particle size distribution than that of) metal-coated resin particles commonly serving as conductive particles, and contain a certain amount of coarse solder particles. Hence, connecting wiring patterns using a conductive composition containing currently commercially-available solder particles may cause short-circuiting as illustrated in FIG. 1 due to a coarse solder particle 11 that is present in a portion to which no pressure is applied between the wiring patterns 10 during thermocompression bonding and assembly. In FIG. 1, the reference numeral 12 denotes solder particles.

Moreover, connecting wiring patterns using a conductive composition containing metal-coated resin particles as conductive particles can secure insulation between the wiring patterns because of an insulating binder present around the metal-coated resin particles. However, connecting wiring patterns using a conductive composition containing solder particles as conductive particles may result in generating a large metallic body 13 as illustrated in FIG. 2 due to solder particles 12 between the wiring patterns 10 melting and auto-agglutinating during thermocompression bonding, and cause short-circuiting due to the large metallic body present in a portion to which no pressure is applied between the wiring patterns during thermocompression bonding and assembly.

In order to avoid the risk of occurrence of such short-circuiting, it is conceivable to form an insulating film on the surface of the solder particles. For example, a proposed solder powder for a solder paste is obtained by forming an oxidized film having an average thickness of from 2.5 nm through 6 nm on the surface of solder particles having a center particle diameter of from 20 micrometers (μm) through 40 μm (for example, see PTL 1).

### CITATION LIST

### Patent Literature

[PTL 1] Japanese Patent No. 4084657

### SUMMARY OF THE INVENTION

### Technical Problem

However, the purpose for which the oxidized film having an average thickness of from 2.5 nm through 6 nm is formed in PTL 1 indicated above is to inhibit temporal increase in the viscosity of a paste after the paste is formed, and is not to avoid the risk of short-circuiting, to inhibit melting and auto-agglutination/coarsening of solder particles present between wiring patterns, and to inhibit reduction in the insulating property. Moreover, PTL 1 indicated above neither describes nor suggests an average surface roughness Ra being 15 nm or greater and 110 nm or less and forming an oxidized film by a forced airflow classification process in an oxygen atmosphere.

Meanwhile, it is difficult to form an insulating film on currently commercially-available solder particles by a mechanochemical method. The reasons for the difficulty are: the nonuniform particle diameter of the currently commercially-available solder particles described above, which makes it difficult to form a uniform insulating film; and solder particles being relatively soft and unable to endure the physical impact of a mechanochemical method, resulting in deformation.

The present invention aims for solving the various problems in the related art described above, and achieving an object described below. That is, an object of the present invention is to provide solder particles, a method for producing solder particles, and a conductive composition that can avoid the risk of short-circuiting and can inhibit reduction in the insulating property.

### Solution to the Problem

Means for solving the problems described above are as follows:

<1> Solder particles, including:
an oxidized film on a surface of the solder particles,
wherein an average film thickness of the oxidized film is 3 nm or greater, and
an average surface roughness Ra of the solder particles is 10 nm or greater.

<2> The solder particles according to <1>,
wherein the average film thickness of the oxidized film is 5 nm or greater and 100 nm or less, and
the average surface roughness Ra of the solder particles is 15 nm or greater and 110 nm or less.

<3> The solder particles according to <1> or <2>,
wherein a number average particle diameter of the solder particles is 1 μm or greater.

<4> The solder particles according to <3>,
wherein a proportion of coarse solder particles having a number-based particle diameter that is 1.25 times or more greater than the number average particle diameter in the solder particles is 0.5 percent (%) or less.

<5> The solder particles according to any one of <1> to <4>, including:
Sn; and
at least one selected from Bi, Ag, Cu, and In.

<6> The solder particles according to any one of <1> to <5>,
wherein the solder particles are produced by a forced airflow classification process in an oxygen-containing atmosphere.

<7> A method for producing solder particles, the method including:
a classifying step of classifying solder particles while forcibly generating an airflow using a classifying device in an oxygen-containing atmosphere.

<8> The method for producing solder particles according to <7>,
wherein the classifying device is a device configured to classify the solder particles while generating the airflow by suctioning by a blower to swirl the solder particles and make the solder particles collide with a surface of a sieve.

<9> The method for producing solder particles according to <7>,
wherein the classifying device is a device including a classifying chamber in which an air vortex swirls together with the solder particles, and that is configured to classify the solder particles by controlling: a swirling centrifugal force generated by rotation of a rotor; and an air current flowing in a direction toward a center of the rotor by means of suctioning by a blower.

<10> A conductive composition, including:
the solder particles of any of <1> to <6>.

### Advantageous Effects of the Invention

The present invention can solve the various problems in the related art described above, achieve the object described above, and provide solder particles, a method for producing solder particles, and a conductive composition that can avoid the risk of short-circuiting and can inhibit reduction in the insulating property.

### BRIEF DESCRIPTION OF THE DRAWINGS

FIG. 1 is an exemplary view illustrating that short-circuiting is caused by a coarse solder particle in a case where commercially available solder particles are used as conductive particles.

FIG. 2 is an exemplary view illustrating that solder particles melt and auto-agglutinate to generate a large metallic body during thermocompression bonding of a solder particle-containing conductive film between wiring patterns.

FIG. 3 includes exemplary views (a) and (b) illustrating that classified solder particles having an increased average surface roughness can have a smaller contact area between solder particles than that between unclassified solder particles having a small average surface roughness.

FIG. 4 includes exemplary views (a) and (b) illustrating that a classified solder particle having an increased average surface roughness can have a greater apparent average oxidized film thickness than that of an unclassified solder particle having a small average surface roughness.

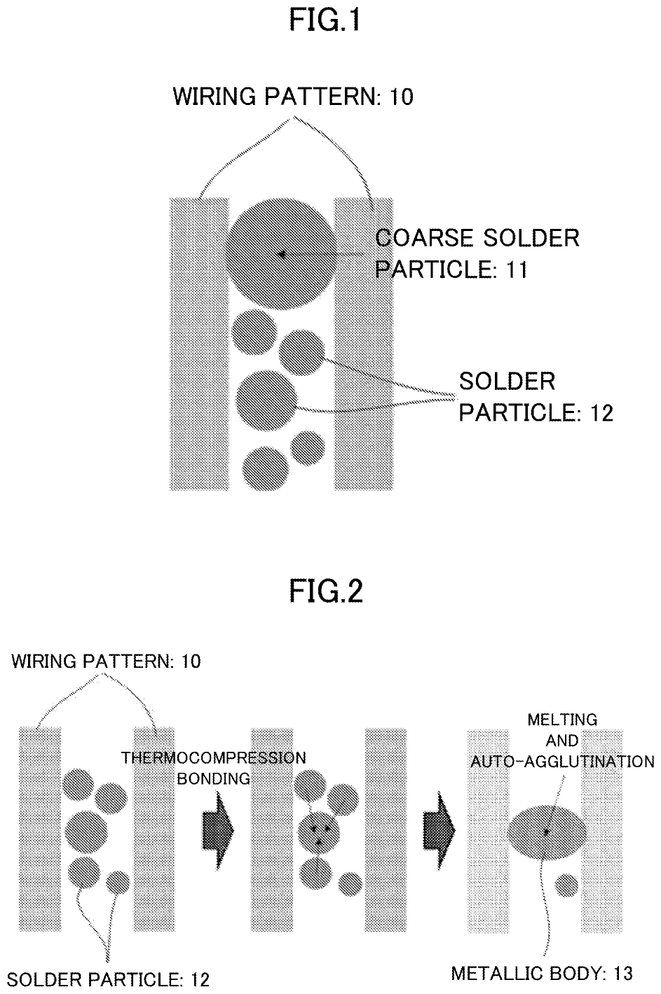

### DESCRIPTION OF EMBODIMENTS

### (Solder Particles)

Solder particles of the present invention contain an oxidized film on the surface of the solder particles. The average film thickness of the oxidized film is 3 nanometers (nm) or greater. The average surface roughness Ra of the solder particles is 10 nm or greater.

The average film thickness of the oxidized film is preferably 5 nm or greater and 100 nm or less. The average surface roughness Ra of the solder particles is preferably 15 nm or greater and 110 nm or less.

In the present invention, classifying solder particles using a forced airflow classifying device in an oxygen-containing atmosphere and removing coarse solder particles contained in commercially available solder particles can avoid the risk of short-circuiting between wiring patterns due to coarse solder particles, and forming an oxidized film on the surface of the solder particles while roughening the surface of the solder particles can inhibit melting and auto-agglutination/coarsening of solder particles present between wiring patterns and inhibit reduction in the insulating property.

The solder particles according to the present invention having an oxidized film on the surface thereof and the average film thickness of the oxidized film being 3 nm or greater can inhibit reduction in the insulating property, because mutually contacting solder particles among the solder particles present in a portion that is, for example, between wiring patterns and to which no pressure is applied during thermocompression bonding and assembly do not melt and merge even if the temperature reaches the melting point of the solder particles.

Currently commercially-available solder particles (unclassified solder particles) cannot obtain the effect described above because their oxidized film has an average film thickness of merely approximately 1 nm.

The upper limit of the thickness of the oxidized film is not particularly limited. However, if the oxidized film of the solder particles is excessively thick, the oxidized film of the solder particles sandwiched between upper and lower electrodes during thermocompression bonding and assembly may fail to rupture and may increase the resistance to conduction. Hence, the average film thickness of the oxidized film is preferably 100 nm or less.

Here, as the average film thickness of the oxidized film, for example, the thickness of the oxidized film in a direction from the surface to the center of a solder particle in a cross-sectional image of the solder particles is measured using a Transmission Electron Microscope (TEM) (JEM-2100plus, available from JEOL Ltd.).

The average film thickness of the oxidized film is an average value obtained by measuring the thickness of the oxidized film at three positions per solder particle, measuring the thickness of the oxidized film from ten solder particles, and averaging these measured values of the thickness of the oxidized film.

With the solder particles according to the present invention, it is possible to form the oxidized film also in the direction of the depth of the solder particles, by the average surface roughness Ra of the solder particles being 10 nm or greater, i.e., by forming undulations in the surface of the solder particles by roughening the surface of the solder particles.

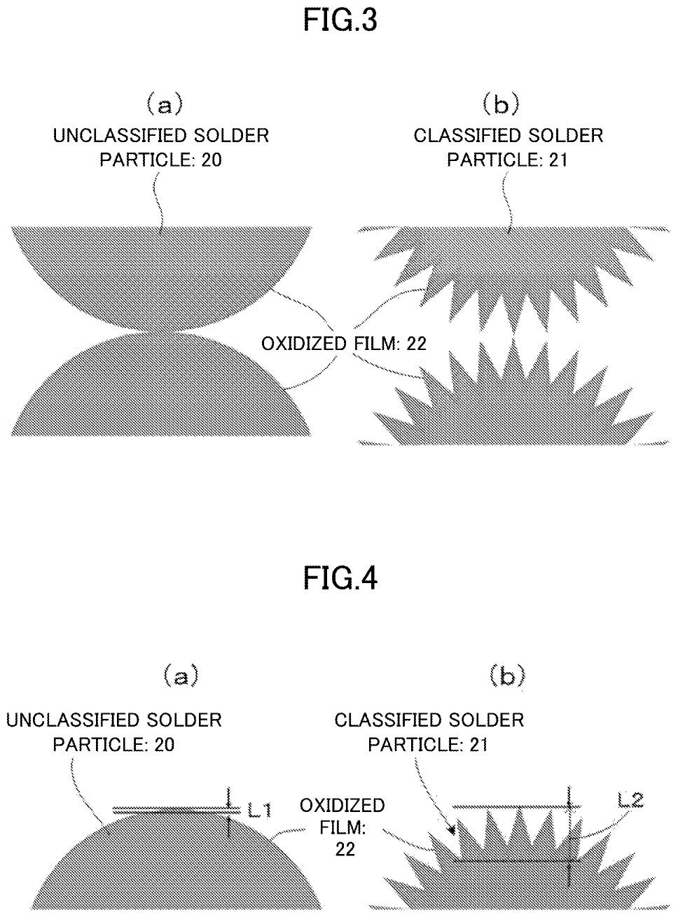

FIG. 3 includes exemplary views (a) and (b) illustrating that classified solder particles 21 having an increased average surface roughness can have a smaller contact area between the solder particles than that between unclassified solder particles 20 having a small average surface roughness. As illustrated in FIG. 3 (b), the classified solder particles 21 according to the present invention having a large average surface roughness Ra can have a smaller contact area between the solder particles than that between the unclassified solder particles 20 illustrated in FIG. 3 (a). In FIG. 3, the reference numeral 22 denotes the oxidized film.

FIG. 4 includes exemplary views (a) and (b) illustrating that a classified solder particle 21 having an increased average surface roughness can have a greater apparent average oxidized film thickness than that of an unclassified solder particle 20 having a small average surface roughness. As illustrated in FIG. 4 (b), by having a large average surface roughness Ra, the classified solder particle 21 according to the present invention can have a classified solder particle's oxidized film thickness L2, which has an apparent increase from an unclassified solder particle's oxidized film thickness L1 of the unclassified solder particle 20 illustrated in FIG. 4 (a). In FIG. 4, the reference numeral 22 denotes the oxidized film.

As illustrated in FIG. 3 and FIG. 4, the solder particles according to the present invention can inhibit reduction in the insulating property, because mutually contacting solder particles among the solder particles present in a portion that is, for example, between wiring patterns and to which no pressure is applied during thermocompression bonding and assembly do not melt and merge even if the temperature reaches the melting point of the solder particles.

Currently commercially-available solder particles (unclassified solder particles) cannot obtain the effect described above because their average surface roughness Ra is merely approximately 1 nm.

The solder particles according to the present invention having an average surface roughness Ra of 10 nm or greater can exhibit the effect described above. The upper limit of the average surface roughness Ra is not particularly limited. However, if the average surface roughness Ra is excessively large, damage in the classification process not only to the surface of the solder particles but also to the entirety of the solder particles becomes large, thereby cracking or chipping the solder particles. Moreover, if the average surface roughness Ra of the solder particles is excessively large, which is the same as the oxidized film being excessively thick, the oxidized film of the solder particles sandwiched between upper and lower electrodes during thermocompression bonding and assembly may fail to rupture and may increase the resistance to conduction. Hence, the average surface roughness Ra is preferably 500 nm or less.

The average surface roughness Ra of the solder particles is an average value obtained by measuring the surface roughness at five positions per solder particle using, for example, an AFM (SPA400 NanoNaviII, available from Hitachi High-Tech Corporation), measuring the surface roughness from ten solder particles, and averaging these measured values of the surface roughness.

Examples of the solder particles include Sn—Pb-based solder particles, Pb—Sn—Sb-based solder particles, Sn—Sb-based solder particles, Sn—Pb—Bi-based solder particles, Bi—Sn-based solder particles, Sn—Cu-based solder particles, Sn—Pb—Cu-based solder particles, Sn—In-based solder particles, Sn—Ag-based solder particles, Sn—Pb—Ag-based solder particles, and Pb—Ag-based solder particles, which are stipulated by Japanese Industrial Standards (JIS) 23282-1999. Solder particles containing Sn and at least one selected from Bi, Ag, Cu, and In are preferable. Specific examples of such solder particles include SnBi, SnBiAg, SnAgCu, and SnIn.

The melting point of the solder particles is preferably 110° C. or higher and 240° C. or lower, and more preferably 120° C. or higher and 200° C. or lower.

The number average particle diameter of the solder particles is preferably 1 μm or greater, more preferably 5 μm or greater, yet more preferably 10 μm or greater, and particularly preferably 15 μm or greater. The upper limit of the number average particle diameter of the solder particles is preferably 30 μm or less, more preferably 25 μm or less, and yet more preferably 20 μm or less.

As the number average particle diameter of the solder particles, a particle size distribution can be expressed by a number frequency obtained by measuring approximately 10,000 particles using, for example, a dry imaging particle size distribution analyzer (Morphologi G3, available from Malvern Panalytical Ltd.).

The proportion of coarse solder particles having a number-based particle diameter that is 1.25 times or more greater than the number-average particle diameter in the solder particles is preferably 0.5% or less, more preferably 0.1% or less, yet more preferably 0.05% or less, particularly preferably 0.01% or less, and the most preferably 0%.

When the proportion of coarse solder particles having a number-based particle diameter that is 1.25 times or more greater than the number-average particle diameter in the solder particles is 0.5% or less, it is possible to avoid occurrence of short-circuiting across wiring patterns due to coarse solder particles.

### (Method for Producing Solder Particles)

A method for producing solder particles according to the present invention includes a classifying step of classifying solder particles while forcibly generating an airflow using a classifying device in an oxygen-containing atmosphere, and further includes other steps as needed.

As the classifying device, a device configured to classify particles while forcibly generating an airflow to disperse the particles and roughen the surface of the particles is used. The classifying device may be (1) a device using a sieve and configured to classify particles by making the particles, which are swirled by an airflow, collide with the sieve and pass through the sieve, or (2) a device free of using a sieve but using a rotor configured to generate a swirling centrifugal force and configured to classify solder particles based on a balance between a centrifugal force generated while making the solder particles collide with the rotor and the drag of air.

As the classifying device (1), there is a device that is configured to classify particles while generating an airflow by suctioning by a blower to swirl the particles and make the particles collide with the surface of a sieve many times. This classifying device classifies solder particles while roughening the surface of the solder particles to an undulated state due to the collision between the solder particles and the surface of the sieve and simultaneously forming an oxidized film. An example of such a classifying device is a SPIN AIR SIEVE (available from Seishin Enterprise Co., Ltd.).

The suctioning pressure of the blower is preferably 0.1 MPa or higher and 1.5 MPa or lower, and more preferably 0.5 MPa or higher and 1.0 MPa or lower.

As the classifying device (2), a device including a classifying chamber in which an air vortex swirls together with solder particles, and that is configured to classify the solder particles into coarse particles and minute particles based on a balance between: a swirling centrifugal force generated by rotation of a rotor; and an air current flowing in a direction toward the center of the rotor by means of suctioning by a blower is used. Solder particles are classified while the surface of the solder particles is roughened to an undulated state due to collision between the solder particles and the surface of the rotor and also while an oxidized film is formed. An example of such a classifying device is a CLASSIEL (available from Seishin Enterprise Co., Ltd.).

The rotation rate of the rotor is preferably 500 rpm or higher and 2,000 rpm or lower, and more preferably 900 rpm or higher and 1,800 rpm or lower.

The classification is performed in an oxygen-containing atmosphere. The oxygen concentration in the oxygen-containing atmosphere is preferably 15 volt or higher and more preferably 20 volt or higher. When the oxygen concentration is 15 volt or higher, it is possible to form a firm oxidized film on the surface of the solder particles. Air can be used as an oxygen-containing atmosphere having an oxygen concentration of 21 volt.

### (Conductive Composition)

A conductive composition according to the present invention contains the solder particles according to the present invention, preferably contains a binder, a monofunctional polymerizable monomer, an elastomer, a curing agent, and a silane coupling agent, and further contains other components as needed.

The conductive composition may be any of a film-shaped conductive film or a paste-like conductive paste. In terms of ease of handling, a conductive film is preferable. Budgetwise, a conductive paste is preferable. In a case where the conductive composition is a conductive film, a film free of solder particles may be laminated over a conductive film containing the solder particles.

—Solder particles—

The solder particles according to the present invention described above are used as the solder particles.

The content of the solder particles in the conductive composition is not particularly limited and may be appropriately adjusted depending on, for example, the wiring pitch and the connection area of a connection structure.

### —Binder—

The binder is not particularly limited and may be appropriately selected in accordance with the intended purpose. Examples of the binder include phenoxy resins, epoxy resins, unsaturated polyester resins, saturated polyester resins, urethane resins, butadiene resins, polyimide resins, polyamide resins, and polyolefin resins. These binder resins may be used alone or in combination of two or more. Among these binder resins, phenoxy resins are particularly preferable in terms of film forming performance, processability, and connection reliability.

The phenoxy resins are resins synthesized from bisphenol A and epichlorohydrin. An appropriately synthesized product may be used or a commercially available product may be used. Examples of the commercially available product include product name: YP-50 (available from Tohto Kasei Co., Ltd.), YP-70 (available from Tohto Kasei Co., Ltd.), and EP1256 (available from Japan Epoxy Resins Co., Ltd.).

The content of the binder in the conductive composition is not particularly limited, may be appropriately selected in accordance with the intended purpose, and is preferably, for example, from 20% by mass through 70% by mass and more preferably from 35% by mass through 55% by mass.

### —Monofunctional Polymerizable Monomer—

The monofunctional polymerizable monomer is not particularly limited and may be appropriately selected in accordance with the intended purpose so long as it contains one polymerizable group in a molecule. Examples of the monofunctional polymerizable monomer include monofunctional (meth)acrylic monomers, styrene monomers, butadiene monomers, and other olefin-based monomers containing a double bond. These monofunctional polymerizable monomers may be used alone or in combination of two or more. Among these monofunctional polymerizable monomers, monofunctional (meth)acrylic monomers are preferable in terms of adhesion strength and connection reliability.

The monofunctional (meth)acrylic monomer is not particularly limited and may be appropriately selected in accordance with the intended purpose. Examples of the monofunctional (meth)acrylic monomer include: acrylic acid or esters thereof, such as acrylic acid, methyl acrylate, ethyl acrylate, propyl acrylate, n-butyl acrylate, isobutyl acrylate, n-octyl acrylate, n-dodecyl acrylate, 2-ethylhexyl acrylate, stearyl acrylate, 2-chloroethyl acrylate, and phenyl acrylate; and methacrylic acid or esters thereof, such as methacrylic acid, methyl methacrylate, ethyl methacrylate, propyl methacrylate, n-butyl methacrylate, isobutyl methacrylate, n-octyl methacrylate, n-dodecyl methacrylate, 2-ethylhexyl methacrylate, stearyl methacrylate, phenyl methacrylate, dimethyl aminoethyl methacrylate, and diethyl aminoethyl methacrylate. These monofunctional (meth)acrylic monomers may be used alone or in combination of two or more.

The content of the monofunctional polymerizable monomer in the conductive composition is not particularly limited, may be appropriately selected in accordance with the intended purpose, and is preferably from 2% by mass through 30% by mass and more preferably from 5% by mass through 20% by mass.

### —Curing Agent—

The curing agent is not particularly limited and may be appropriately selected in accordance with the intended purpose so long as it can cure the binder. For example, an organic peroxide is preferable.

Examples of the organic peroxide include lauroyl peroxide, butyl peroxide, benzyl peroxide, dilauroyl peroxide, dibutyl peroxide, benzyl peroxide, peroxydicarbonate, and benzoyl peroxide. These organic peroxides may be used alone or in combination of two or more.

The content of the curing agent in the conductive composition is not particularly limited, may be appropriately selected in accordance with the intended purpose, and is preferably 1% by mass or greater and 15% by mass or less and more preferably 3% by mass or greater and 10% by mass or less.

### —Elastomer—

The elastomer is not particularly limited and may be appropriately selected in accordance with the intended purpose. Examples of the elastomer include polyurethane-based elastomers, acrylic rubbers, silicone rubbers, and butadiene rubbers These elastomers may be used alone or in combination of two or more.

### —Silane Coupling Agent—

The silane coupling agent is not particularly limited and may be appropriately selected in accordance with the intended purpose. Examples of the silane coupling agent include epoxy-based silane coupling agents, acrylic-based silane coupling agents, thiol-based silane coupling agents, and amine-based silane coupling agents.

The content of the silane coupling agent in the conductive composition is not particularly limited, may be appropriately selected in accordance with the intended purpose, and is preferably 0.5% by mass or greater and 10% by mass or less and more preferably 1% by mass or greater and 5% by mass or less.

### —Other Components—

The other components are not particularly limited and may be appropriately selected in accordance with the intended purpose. Examples of the other components include an organic solvent, a bulking agent, a softener, an accelerator, an antiaging agent, a colorant (pigment and dye), and an ion-trapping agent. The addition amounts of the other components are not particularly limited and may be appropriately selected in accordance with the intended purpose.

### <Use>

The solder particles and the conductive composition according to the present invention, which can avoid the risk of short-circuiting and inhibit reduction in the insulating property, can be used for electrical connection between electrodes of various connection-target components such as connection between a flexible printed circuit and a glass substrate (Film on Glass (FOG)), connection between a semiconductor chip and a flexible printed circuit (Chip on Film (COF)), connection between a semiconductor chip and a glass substrate (Chip on Glass (COG)), connection between a flexible printed circuit and a glass epoxy substrate (Film on Board (FOB)), and the like.

### EXAMPLES

The present invention will be described below by way of Examples. The present invention should not be construed as being limited to these Examples.

### <Measurement of Particle Size Distribution>

Approximately ten thousand particles were measured using a dry imaging particle size distribution analyzer (Morphologi G3, obtained from Malvern Panalytical Ltd.), and the particle size distribution was expressed by number frequency.

### <Measurement of Average Film Thickness of Oxidized Film>

The thickness of an oxidized film was measured in a direction from the surface to the center of a solder particle in a cross-sectional image of solder particles, using a Transmission Electron Microscope (TEM) (JEM-2100plus, obtained from JEOL Ltd.).

The average film thickness of an oxidized film was an average value obtained by measuring the thickness of the oxidized film at three positions per solder particle, measuring the thickness of the oxidized film from ten solder particles, and averaging these measured values of the thickness of the oxidized film.

### <Measurement of Average Surface Roughness Ra>

The average surface roughness was an average value obtained by measuring the surface roughness at five positions per solder particle using an Atomic Force Microscope (AFM) (SPA400 NanoNaviII, obtained from Hitachi High-Tech Corporation), measuring the surface roughness from ten solder particles, and averaging these measured values of the surface roughness.

### <Measurement of Endothermic Peak of Solder Particles by DSC>

An endothermic peak of solder particles by DSC was measured using a Differential Scanning Calorimeter (DSC) (EXSTAR DSC6200, obtained from Seiko Instruments Inc. (SII)).

### <SEM Observation of the Surface of Solder Particles>

SEM observation of the surface of solder particles was performed using a Scanning Electron Microscope (SEM) (JSM-6510A, obtained from JEOL Ltd.).

### Example 1

### <Classification of Solder Particles>

As solder particles, Sn₄₂Bi₅₈-Type5 (obtained from Mitsui Mining & Smelting Co., Ltd.) was prepared. The result of measuring Sn₄₂Bi₅₈-Type5 using a dry imaging particle size distribution analyzer (Morphologi G3, obtained from Malvern Panalytical Ltd.) indicated that the particle size distribution was from 15 μm through 25 μm, that the cumulative 50% number-based particle diameter (D₅₀) was 20 μm, and that the proportion of coarse solder particles having a number-based particle diameter of 25 μm or greater was 5%.

A metallic twilled mesh sieve (obtained from Tokyo Screen Co., Ltd.) having a diameter of 200 mm and a mesh size of 20 μm was set on a SPIN AIR SIEVE (obtained from Seishin Enterprise Co., Ltd.), and the particles were suctioned by a blower at a suctioning pressure of 0.5 kPa. The solder particles (50 g) were fed from a raw material feeding port. The device was operated in the air for 5 minutes from the feeding of the raw material until the end of the classification, and minute particles that passed through the sieve by one time of a forced airflow classification process were recovered and obtained as classified solder particles.

The result of measuring the obtained classified solder particles using the dry imaging particle size distribution analyzer (Morphologi G3, obtained from Malvern Panalytical Ltd.) indicated that the proportion of coarse solder particles having a number-based particle diameter of 25 μm or greater was 0.01%. It was observed by Scanning Electron Microscopic (SEM) observation that the surface of the obtained classified solder particles was undulated. An endothermic peak of the classified solder particles measured by a Differential Scanning Calorimeter (DSC) was 141° C. As a result of a SEM observation of the classified solder particles after the DSC measurement, it was observed that there was almost no mutual agglutination of the particles due to melting of the particles in the classified solder particles, compared with the unclassified solder particles.

As a result of measuring the thickness of the oxidized film in a direction from the surface to the center of the classified solder particles using a Transmission Electron Microscope (TEM), it was confirmed that the average film thickness of the oxidized film was 5 nm, and that the thickness of the oxidized film was greater than that of the unclassified solder particles.

As a result of measuring the average surface roughness Ra of the classified solder particles using an Atomic Force Microscope (AFM), it was confirmed that the average surface roughness Ra was 15 nm, and that the average surface roughness Ra was greater than that of the unclassified solder particles.

### <Production of Conductive Film>

The produced solder particles of Example 1 (5 parts by mass), and an insulating binder described below (95 parts by mass) were fed into a planetary stirrer and stirred for 1 minute, to produce a conductive composition.

Next, the conductive composition was applied over a PET film having a thickness of 50 μm and dried in an oven at 80° C. for 5 minutes, to form a tacky layer made of the conductive composition and having a thickness of 25 μm over the PET film and produce a conductive film having a width of 2.0 mm.

### —Insulating Binder—

The insulating binder was prepared as an ethyl acetate/toluene mixture solution containing a phenoxy resin (product name: YP-50, obtained from Shin Nikka Epoxy Manufacturing Co., Ltd.) (47 parts by mass), a monofunctional monomer (product name: M-5300, obtained from Toagosei Co., Ltd.) (3 parts by mass), a urethane resin (product name: UR-1400, obtained from Toyobo Co., Ltd.) (25 parts by mass), a rubber component (product name: SG80H, obtained from Nagase ChemteX Corporation) (15 parts by mass), a silane coupling agent (product name: A-187, obtained from Momentive Performance Materials Japan LLC) (2 parts by mass), and an organic peroxide (product name: NIPER BW, obtained from NOF Corporation) (3 parts by mass) such that a solid component concentration would be 50% by mass.

### <Production of Connection Structure>

A substrate for evaluation (a glass epoxy substrate (FR4) having a pitch of 200 μm, a line: space ratio of 1:1, and a terminal thickness of 10 μm, and plated with Cu (base)/Ni/Au), and a FPC (a polyimide film, having a pitch of 200 μm, a line: space ratio of 1:1, and a terminal thickness of 12 μm, and plated with Cu (base)/Ni/Au) were thermocompression-bonded via the conductive film described above, to produce a connection structure.

Thermocompression bonding was performed at a temperature of 150° C. at a pressure of 2 MPa for a time of 20 sec, by pushing a tool down via a silicone rubber that was over the FPC and had a thickness of 200 μm.

### <Evaluation of Conduction Property>

An initial resistance to conduction in the produced connection structure in flowing a current of 1 mA was measured using a digital multimeter (obtained from Yokogawa Electric Corporation) by a 4-terminal method, and was evaluated in accordance with the criteria listed below.

An initial insulation resistance was also measured by applying a voltage across the patterns of the connection structure, to confirm presence or absence of short-circuiting. An initial insulation resistance of 1×10⁵Ω or lower was evaluated as being No Good as short-circuit occurred.

### [Evaluation Criteria]

A: The resistance to conduction was 1Ω or lower.

B: The resistance to conduction was higher than 1Ω.

C: The resistance to conduction was OPEN.

### Example 2

### <Classification of Solder Particles>

Solder particles of Example 2 were produced by performing a forced airflow classification process in the same manner as in Example 1, except that unlike in Example 1, the number of times of classifications among the classification conditions was changed to three times.

### <Production of Conductive Film, Production of Connection Structure, and Evaluation>

A conductive film and a connection structure were produced in the same manner as in Example 1 using the produced solder particles of Example 2, and were evaluated. The results are indicated in Table 1.

### Example 3

### <Classification of Solder Particles>

Solder particles of Example 3 were produced by performing a forced airflow classification process in the same manner as in Example 1, except that unlike in Example 1, the suctioning pressure among the classification conditions was changed to 1 MPa.

### <Production of Conductive Film, Production of Connection Structure, and Evaluation>

A conductive film and a connection structure were produced in the same manner as in Example 1 using the produced solder particles of Example 3, and were evaluated. The results are indicated in Table 1.

### Example 4

### <Classification of Solder Particles>

Solder particles of Example 4 were produced by performing a forced airflow classification process in the same manner as in Example 1, except that unlike in Example 1, Sn₄₂Bi₅₈-Type5 was changed to Sn₄₂Bi₅₈Ag₁-Type5 (obtained from Senju Metal Industry Co., Ltd.).

The result of measuring SnazBissAgi-Type5 using a dry imaging particle size distribution analyzer (Morphologi G3, obtained from Malvern Panalytical Ltd.) indicated that the particle size distribution was from 15 μm through 25 μm, that the cumulative 50% number-based particle diameter (D₅₀) was 20 μm, and that the proportion of coarse particles having a number-based particle diameter of 25 μm or greater was 6%.

### <Production of Conductive Film, Production of Connection Structure, and Evaluation>

A conductive film and a connection structure were produced in the same manner as in Example 1 using the produced solder particles of Example 4, and were evaluated. The results are indicated in Table 2.

### Example 5

### <Classification of Solder Particles>

Sn₄₂Bi₅₈-Type5 (obtained from Mitsui Mining & Smelting Co., Ltd.), which was used as solder particles, was suctioned to a CLASSIEL (obtained from Seishin Enterprise Co., Ltd.) with a rotor, which was attached to the CLASSIEL, rotated at 900 rpm, and further with a blower at an intensity of 3 m³/min. The solder particles (50 g) were fed from a raw material feeding port. The device was operated in the air for 5 minutes from the feeding of the raw material until the end of the classification, and minute particles were recovered by one time of a forced airflow classification process and obtained as classified solder particles.

The result of measuring the obtained classified solder particles using a particle size distribution analyzer indicated that the proportion of coarse solder particles having a number-based particle diameter of 25 μm or greater was 08. It was observed by SEM observation that the surface of the obtained classified solder particles was undulated. An endothermic peak of the classified solder particles measured by a Differential Scanning Calorimeter (DSC) was 141° C. As a result of a Scanning Electron Microscopic (SEM) observation of the particles after the DSC measurement, it was observed that there was almost no mutual agglutination of the particles due to melting of the particles in the classified solder particles, compared with the unclassified solder particles.

As a result of measuring the thickness of the oxidized film in a direction from the surface to the center of the classified solder particles using a Transmission Electron Microscope (TEM), it was confirmed that the average film thickness of the oxidized film was 8 nm, and that the average film thickness of the oxidized film was greater than that of the unclassified solder particles.

As a result of measuring the average surface roughness Ra of the classified solder particles using an Atomic Force Microscope (AFM), it was confirmed that the average surface roughness Ra was 20 nm, and that the average surface roughness Ra was greater than that of the unclassified solder particles.

### <Production of Conductive Film, Production of Connection Structure, and Evaluation>

A conductive film and a connection structure were produced in the same manner as in Example 1 using the produced solder particles of Example 5, and were evaluated. The results are indicated in Table 2.

### Example 6

### <Classification of Solder Particles>

Solder particles of Example 6 were produced by performing a forced airflow classification process in the same manner as in Example 1, except that unlike in Example 5, the rotor rotation rate among the classification conditions was changed to 1,200 rpm.

### <Production of Conductive Film, Production of Connection Structure, and Evaluation>

A conductive film and a connection structure were produced in the same manner as in Example 1 using the produced solder particles of Example 6, and were evaluated. The results are indicated in Table 2.

### Example 7

### <Classification of Solder Particles>

Solder particles of Example 7 were produced by performing a forced airflow classification process in the same manner as in Example 1, except that unlike in Example 5, the rotor rotation rate among the classification conditions was changed to 1,800 rpm.

### <Production of Conductive Film, Production of Connection Structure, and Evaluation>

A conductive film and a connection structure were produced in the same manner as in Example 1 using the produced solder particles of Example 7, and were evaluated. The results are indicated in Table 3.

### Comparative Example 1

As solder particles, Sn₄₂Bi₅₈-Type5 (obtained from Mitsui Mining & Smelting Co., Ltd.) was used as is without classification.

An endothermic peak of the solder particles measured by a Differential Scanning Calorimeter (DSC) was 141° C. As a result of a Scanning Electron Microscopic (SEM) observation of the particles after the DSC measurement, it was observed that there was much of mutual agglutination of the particles due to melting of the particles.

As a result of measuring the thickness of the oxidized film in a direction from the surface to the center of the classified solder particles using a Transmission Electron Microscope (TEM), it was confirmed that the average film thickness of the oxidized film was 1 nm, and that the average film thickness of the oxidized film was smaller than that of the classified solder particles of Examples 1 to 7. As a result of measuring the average surface roughness Ra of the solder particles using an Atomic Force Microscope (AFM), it was confirmed that the average surface roughness Ra was 5 nm, and that the average surface roughness Ra was smaller than that of the classified solder particles of Examples 1 to 7.

### <Production of Conductive Film, Production of Connection Structure, and Evaluation>

A conductive film and a connection structure were produced in the same manner as in Example 1 using the solder particles of Comparative Example 1, and were evaluated. The results are indicated in Table 3.

### Comparative Example 2

### <Classification of Solder Particles>

Sn₄₂Bi₅₈-Type5 (obtained from Mitsui Mining & Smelting Co., Ltd.) was used as solder particles. Sn₄₂Bi₅₈-Type5 was classified to remove coarse solder particles using a sieve having a mesh size of #20 μm on a sieve shaker (VUD-80, obtained from Tsutsui Scientific Instruments Co., Ltd.).

The result of measuring the obtained classified solder particles using a particle size distribution analyzer indicated that the proportion of coarse solder particles having a number-based particle diameter of 25 μm or greater was 0%. It was observed by Scanning Electron Microscopic (SEM) observation that the surface of the obtained classified solder particles was almost unchanged from before they were classified. An endothermic peak of the classified solder particles measured by a Differential Scanning Calorimeter (DSC) was 141° C. As a result of a SEM observation of the particles after the DSC measurement, it was observed that there was much of mutual agglutination of the particles due to melting of the particles.

As a result of measuring the average film thickness of the oxidized film in a direction from the surface to the center of the classified solder particles using a Transmission Electron Microscope (TEM), it was confirmed that the average film thickness of the oxidized film was 2 nm, and that the average film thickness of the oxidized film was smaller than that of the classified solder particles of Examples 1 to 7.

As a result of measuring the average surface roughness Ra of the classified solder particles using an Atomic Force Microscope (AFM), it was confirmed that the average surface roughness Ra was 8 nm, and that the average surface roughness Ra was smaller than that of the classified solder particles of Examples 1 to 7.

### <Production of Conductive Film, Production of Connection Structure, and Evaluation>

A conductive film and a connection structure were produced in the same manner as in Example 1 using the produced solder particles of Comparative Example 2, and were evaluated. The results are indicated in Table 3.

TABLE 1

| | | | Ex. 1 | Ex. 2 | Ex. 3 |
|---|---|---|---|---|---|
| Raw | Solder | Material | Sn₄₂Bi₅₈ | Sn₄₂Bi₅₈ | Sn₄₂Bi₅₈ |
| material | particles | Particle | Type 5 | Type 5 | Type 5 |
| | | dia. type | | | |
| | | Cuml. 50% | 20 μm | 20 μm | 20 μm |
| | | number-based | | | |
| | | particle | | | |
| | | dia. (D₅₀) | | | |
| | | Prop. of | 5% | 5% | 5% |
| | | coarse | | | |
| | | particles ≥ | | | |
| | | 25 μm in | | | |
| | | dia. | | | |
| Classi- | Classif. | Classif. | SPIN | SPIN | SPIN |
| fication | conditions | Device | AIR | AIR | AIR |
| | | | SIEVE | SIEVE | SIEVE |
| | | Sieve mesh | 20 μm | 20 μm | 20 μm |
| | | size | | | |
| | | Classif. | SUC | SUC | SUC |
| | | Condition | pressure = | pressure = | pressure = |
| | | | 0.5 MPa | 0.5 MPa | 1 MPa |
| | | Number of | 1 | 3 | 1 |
| | | classifs. | | | |
| | Classified | Prop. of | 0.01% | 0% | 0% |
| | solder | coarse | | | |
| | particles | particles ≥ | | | |
| | | 25 μm in | | | |
| | | dia. | | | |
| | DSC Eval. | Endothermic | 141 | 141 | 141 |
| | of | peak temp. | | | |
| | classified | (° C.) | | | |
| | solder | Pres. or | Abs. | Abs. | Abs. |
| | particles | Abs. of | | | |
| | | particle | | | |
| | | melting/AGGL | | | |

| | | | | |
|---|---|---|---|---|
| | Average oxidized film | 5 | 30 | 20 |
| | thickness (nm) | | | |
| | Average surface | 15 | 60 | 45 |
| | roughness Ra (nm) | | | |
| Eval- | Initial conduction | A | A | A |
| uation | evaluation | | | |
| | Initial insulation | Abs. of | Abs. of | Abs. of |
| | evaluation (Pres, or | occur. | occur. | occur. |
| | Abs. of occur, of short- | of | of | of |
| | circuiting) | short- | short- | short- |
| | | circuiting | circuiting | circuiting |

TABLE 2

| | | | Ex. 4 | Ex. 5 | Ex. 6 |
|---|---|---|---|---|---|
| Raw | Solder | Material | Sn₄₂Bi₅₇Ag₁ | Sn₄₂Bi₅₈ | Sn₄₂Bi₅₈ |
| material | particles | Particle | Type 5 | Type 5 | Type 5 |
| | | dia. type | | | |
| | | Cuml. 50% | 20 μm | 20 μm | 20 μm |
| | | number- | | | |
| | | based | | | |
| | | particle | | | |
| | | dia. (D₅₀) | | | |
| | | Prop. of | 6% | 5% | 5% |
| | | coarse | | | |
| | | particles ≥ | | | |
| | | 25 μm in | | | |
| | | dia. | | | |
| Classi- | Classif. | Classif. | SPIN AIR | CLASSIEL | CLASSIEL |
| fication | conditions | Device | SIEVE | | |
| | | Sieve mesh | 20 μm | No sieve | No sieve |
| | | size | | used | used |
| | | Classif. | SUC | Rotor | Rotor |
| | | Condition | pressure = | rot. | rot. |
| | | | 0.5 MPa | rate = | rate = |
| | | | | 900 rpm | 1,200 |
| | | | | | rpm |
| | | Number of | 1 | 1 | 1 |
| | | classifs. | | | |
| | Classified | Prop. of | 0.01% | 0.03% | 0% |
| | solder | coarse | | | |
| | particles | particles ≥ | | | |
| | | 25 μm in | | | |
| | | dia. | | | |
| | DSC | Endo- | 140 | 141 | 141 |
| | Eval. of | thermic | | | |
| | classified | peak temp. | | | |
| | solder | (° C.) | | | |
| | particles | Pres. or | Abs. | Abs. | Abs. |
| | | Abs. of | | | |
| | | particle | | | |
| | | melting/ | | | |
| | | AGGL | | | |

| | | | | |
|---|---|---|---|---|
| | Average oxidized film | 6 | 8 | 20 |
| | thickness (nm) | | | |
| | Average surface | 19 | 20 | 50 |
| | roughness Ra (nm) | | | |
| Eval- | Initial conduction | A | A | A |
| uation | evaluation | | | |
| | Initial insulation | Abs. of | Abs. of | Abs. of |
| | evaluation (Pres. or | occur. of | occur. | occur. |
| | Abs. of occur. of | short- | of | of |
| | short-circuiting) | circuiting | short- | short- |
| | | | circuiting | circuiting |

TABLE 3

| | | | | Comp. | Comp. |
|---|---|---|---|---|---|
| | | | Ex. 7 | Ex. 1 | Ex. 2 |
| Raw | Solder | Material | Sn₄₂Bi₅₈ | Sn₄₂Bi₅₈ | Sn₄₂Bi₅₈ |
| material | particles | Particle | Type 5 | Type 5 | Type 5 |
| | | dia. type | | | |
| | | Cuml. 50% | 20 μm | 20 μm | 20 μm |
| | | number-based | | | |
| | | particle | | | |
| | | dia. (D₅₀) | | | |
| | | Prop. of | 5% | 5% | 5% |
| | | Coarse | | | |
| | | particles ≥ | | | |
| | | 25 μm in | | | |
| | | dia. | | | |
| Classi- | Classif. | Classif. | CLASSIEL | — | Vibrating |
| fication | conditions | Device | | | sieve |
| | | Sieve mesh | No sieve | — | 20 μm |
| | | size | used | | |
| | | Classif. | Rotor | — | — |
| | | Condition | rot. | | |
| | | | rate = | | |
| | | | 1,800 rpm | | |
| | | Number of | 1 | — | 1 |
| | | classifs. | | | |
| | Classified | Prop. of | 0% | — | 0% |
| | solder | coarse | | | |
| | particles | particles ≥ | | | |
| | | 25 μm in | | | |
| | | dia. | | | |
| | DSC | Endothermic | 141 | 141 | 141 |
| | Eval. of | peak temp. | | | |
| | classified | (° C.) | | | |
| | solder | Pres. or | Abs. | Pres. | Pres. |
| | particles | Abs. of | | | |
| | | particle | | | |
| | | melting/ | | | |
| | | AGGL | | | |

| | | | | |
|---|---|---|---|---|
| | Average oxidized film | 50 | 1 | 2 |
| | thickness (nm) | | | |
| | Average surface | 120 (with | 5 | 8 |
| | roughness Ra (nm) | particle | | |
| | | cracking) | | |
| Eval- | Initial conduction | B | A | A |
| uation | evaluation | | | |
| | Initial insulation | Abs. of | Pres. of | Pres. of |
| | evaluation (Pres. or | occur. of | occur. | occur. |
| | Abs. of occur. of short- | short- | of | of |
| | circuiting) | circuiting | short- | short- |
| | | | circuiting | circuiting |

From the results in Table 1 to Table 3, it was revealed that the initial resistance to conduction and the initial insulation resistance were both obtained as favorable values in Examples 1 to 7.

In Comparative Example 1, the initial resistance to conduction was good, whereas short-circuiting occurred in the measurement of the initial insulation resistance. As a result of observing the gap between the patterns of the channel through which the short-circuiting occurred, a portion in which a solder particle of a size of a sphere having a diameter of approximately 30 μm was inserted, and a portion in which abnormally-shaped solder resulting from solder particles melting and growing to a coarse solder particle was present were observed.

In Comparative Example 2, the initial resistance to conduction was good, whereas short-circuiting occurred in the measurement of the initial insulation resistance. As a result of observing the gap between the patterns of the channel through which the short-circuiting occurred, a portion in which an abnormally-shaped solder resulting from solder particles melting and growing to a coarse solder particle was present was observed.

### INDUSTRIAL APPLICABILITY

The solder particles and the conductive composition according to the present invention, which can avoid the risk of short-circuiting and inhibit reduction in the insulating property, can be favorably used for, for example, connection of a terminal of a Flexible Printed Circuit (FPC) or an IC chip with an Indium Tin Oxide (ITO) electrode formed over a glass substrate of a LCD panel, connection of COF with PWB, connection of TCP with PWB, connection of COF with a glass substrate, connection of COF with COF, connection of an IC substrate with a glass substrate, connection of an IC substrate with PWB, and the like.

The present international application claims priority to Japanese Patent Application No. 2021-138864 filed Aug. 27, 2021. The entire contents of Japanese Patent Application No. 2021-138864 are incorporated herein by reference.

### REFERENCE SIGNS LIST

10 wiring pattern
11 coarse solder particle
12 solder particle
13 metallic body
20 unclassified solder particle
21 classified solder particle
22 oxidized film
L1 unclassified solder particle's oxidized film thickness
L2 classified solder particle's oxidized film thickness

1. Solder particles, comprising:
an oxidized film on a surface of the solder particles,
wherein an average film thickness of the oxidized film is 3 nm or greater, and
an average surface roughness Ra of the solder particles is 10 nm or greater.

2. The solder particles according to claim 1,
wherein the average film thickness of the oxidized film is 5 nm or greater and 100 nm or less, and
the average surface roughness Ra of the solder particles is 15 nm or greater and 110 nm or less.

3. The solder particles according to claim 1,
wherein a number average particle diameter of the solder particles is 1 μm or greater.

4. The solder particles according to claim 3,
wherein a proportion of coarse solder particles having a number-based particle diameter that is 1.25 times or more greater than the number average particle diameter in the solder particles is 0.5% or less.

5. The solder particles according to claim 1, comprising:
Sn; and
at least one selected from Bi, Ag, Cu, and In.

6. The solder particles according to claim 1,
wherein the solder particles are produced by a forced airflow classification process in an oxygen-containing atmosphere.

7. A method for producing solder particles, the method comprising:
classifying solder particles while forcibly generating an airflow using a classifying device in an oxygen-containing atmosphere.

8. The method for producing solder particles according to claim 7,
wherein the classifying device is a device configured to classify the solder particles while generating the airflow by suctioning by a blower to swirl the solder particles and make the solder particles collide with a surface of a sieve.

9. The method for producing solder particles according to claim 7,
wherein the classifying device is a device including a classifying chamber in which an air vortex swirls together with the solder particles, and that is configured to classify the solder particles by controlling: a swirling centrifugal force generated by rotation of a rotor; and an air current flowing in a direction toward a center of the rotor by means of suctioning by a blower.

10. A conductive composition, comprising:
the solder particles of claim 1.
